(19) United States
(12) Patent Application Publication
(10) Pub. No.: US 2016/0218579 A1
(43) Pub. Date: Jul. 28, 2016

(54) HYBRID MOTOR STRUCTURE

(71) Applicant: INDUSTRIAL TECHNOLOGY RESEARCH INSTITUTE, HSIN-CHU (TW)

(72) Inventors: MING-TSAN PENG, Jhongli City (TW); SHAO-YU LEE, Hsinchu County (TW)

(21) Appl. No.: 14/940,806

(22) Filed: Nov. 13, 2015

(30) Foreign Application Priority Data
Nov. 14, 2014 (TW) 103139627

(51) Int. Cl. H02K 3/28; H02K 7/10; H02K 11/00

(52) U.S. Cl. CPC H02K 3/28; H02K 11/0094; H02K 7/10

(57) ABSTRACT

A hybrid motor structure is provided; the motor may include a stator, a rotor, a first coil, a first magnet set, a second coil and a second magnet set. The stator may include a plurality of stator teeth. The rotor may be installed on the stator. The first coil may be wound on the stator teeth. The first magnet set may include a plurality of first magnet blocks; the first magnet blocks may be disposed around the rotor and corresponding to the first coil. The second magnet set may include a plurality of second magnet blocks disposed around the rotor and corresponding to the second coil. The hybrid motor structure can be applied to various kinds of motors, such as radial motor and axial motor, etc.

### CROSS REFERENCE TO RELATED APPLICATION

This application also claims priority to Taiwan Patent Application No. 103139627 filed in the Taiwan Patent Office on Nov. 14, 2014, the entire content of which is incorporated herein by reference.

### TECHNICAL FIELD

The present disclosure relates to a motor structure, in particular to a hybrid motor structure.

### BACKGROUND

Generally speaking, in-wheel motor of electric motor, integrated starter generator and other similar applications are required to be of small size and light in weight; besides, they also need to simultaneously provide high torque in low speed and wide speed region; therefore, it is a great challenge to design a motor capable of meeting the above requirements.

Please refer to FIG. 1, which is the schematic view of the power output characteristics of the conventional motor. As shown in FIG. 1, the curve A and the curve B illustrate the power output curves of the conventional motor with different torque outputs. When the torque output of the motor needs to be increased without significantly decreasing its speed region, the motor's power output curve will change from the curve A to the curve B; the maximum power point of the curve A is P1 and the maximum power point of the curve B is P2, where the maximum point is the product of the rotation speed (rpm) and the torque (Nm). Thus, as described above, the rotation speed and torque of the curve B's maximum power point P2 are higher than the rotation speed and torque of the curve A's maximum power point P1; accordingly, the increase of the power of the motor will not be proportional to the increase of the torque of the motor. In other words, the conventional motor needs to significantly increase its power in order to provide high torque; however, it is very hard for the conventional motor to significantly increase its power because the size and weight of the conventional motor are limited.

Currently, many different motors have been developed for the above applications. For example, Taiwan patent publication No. 201301717 provides an electromagnetic speed-variable motor; U.S. Pat. No. 7,569,970 provides an electric motor with multiple rotors; Taiwan patent publication No. 521710 provides an electricity-aided modularized wheel hub. However, the above motors still have a lot of shortcomings to be overcome.

### SUMMARY

The present disclosure is related to a hybrid motor structure. In one embodiment of the disclosure, the hybrid motor structure may include a rotor, a stator, a first coil, a first magnet set, a second coil and a second magnet set. The rotor and the stator may be arranged in the radial direction of the hybrid motor structure, and the stator may include a plurality of stator teeth. The first coil may be wound on the stator teeth. The first magnet set may include a plurality of first magnet blocks; the first magnet blocks may be disposed around the rotor and corresponding to the first coil; the first magnet set and the first coil may form the first groove pole. The second coil may be wound on the stator teeth. The second magnet set may include a plurality of second magnet blocks; the second magnet blocks may be disposed around the rotor and corresponding to the second coil; the second magnet set and the second coil may form the second groove pole.

In another embodiment of the disclosure, the hybrid motor structure may include a rotor, a stator, a first coil, a first magnet set, a second coil and a second magnet set. The rotor and the stator may be arranged in the serial direction of the hybrid motor structure, and the stator may include a plurality of stator teeth. The first coil may be wound on the stator teeth. The first magnet set may include a plurality of first magnet blocks; the first magnet blocks may be disposed around the rotor and corresponding to the first coil; the first magnet set and the first coil may form the first groove pole. The second coil may be wound on the stator teeth. The second magnet set may include a plurality of second magnet blocks; the second magnet blocks may be disposed around the rotor and corresponding to the second coil; the second magnet set and the second coil may form the second groove pole.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is the schematic view of the power output characteristics of the conventional motor.

FIG. 2 is the first schematic view of the first embodiment of the hybrid motor structure in accordance with the present invention.

FIG. 3 is the second schematic view of the first embodiment of the hybrid motor structure in accordance with the present invention.

FIG. 4 is the third schematic view of the first embodiment of the hybrid motor structure in accordance with the present invention.

FIG. 5A is the fourth schematic view of the first embodiment of the hybrid motor structure in accordance with the present invention.

FIG. 5B is the fifth schematic view of the first embodiment of the hybrid motor structure in accordance with the present invention.

FIG. 6 is the sixth schematic view of the first embodiment of the hybrid motor structure in accordance with the present invention.

FIG. 7 is the seventh schematic view of the first embodiment of the hybrid motor structure in accordance with the present invention.

FIG. 8 is the eighth schematic view of the first embodiment of the hybrid motor structure in accordance with the present invention.

FIG. 9 is the ninth schematic view of the first embodiment of the hybrid motor structure in accordance with the present invention.

FIG. 10 is the tenth schematic view of the first embodiment of the hybrid motor structure in accordance with the present invention.

FIG. 11 is the eleventh schematic view of the first embodiment of the hybrid motor structure in accordance with the present invention.

FIG. 12 is the twelfth schematic view of the first embodiment of the hybrid motor structure in accordance with the present invention.

FIG. 13 is the thirteenth schematic view of the first embodiment of the hybrid motor structure in accordance with the present invention.

FIG. 14 is the fourteenth schematic view of the first embodiment of the hybrid motor structure in accordance with the present invention.

FIG. 15 is the fifteenth schematic view of the first embodiment of the hybrid motor structure in accordance with the present invention.

FIG. 16 is the sixteenth schematic view of the first embodiment of the hybrid motor structure in accordance with the present invention.

FIG. 17 is the seventeenth schematic view of the first embodiment of the hybrid motor structure in accordance with the present invention.

FIG. 18 is the first schematic view of the second embodiment of the hybrid motor structure in accordance with the present invention.

FIG. 19 is the second schematic view of the second embodiment of the hybrid motor structure in accordance with the present invention.

FIG. 20A is the third schematic view of the second embodiment of the hybrid motor structure in accordance with the present invention.

FIG. 20B is the fourth schematic view of the second embodiment of the hybrid motor structure in accordance with the present invention.

FIG. 21 is the fifth schematic view of the second embodiment of the hybrid motor structure in accordance with the present invention.

FIG. 22 is the sixth schematic view of the second embodiment of the hybrid motor structure in accordance with the present invention.

FIG. 23 is the seventh schematic view of the second embodiment of the hybrid motor structure in accordance with the present invention.

FIG. 24 is the schematic view of the third embodiment of the hybrid motor structure in accordance with the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

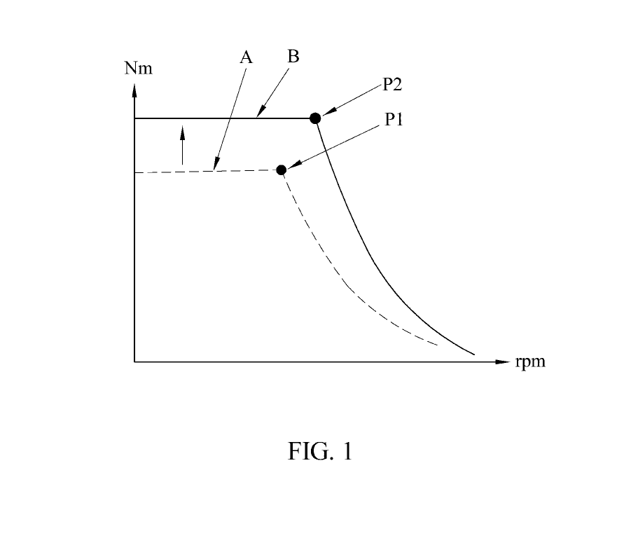

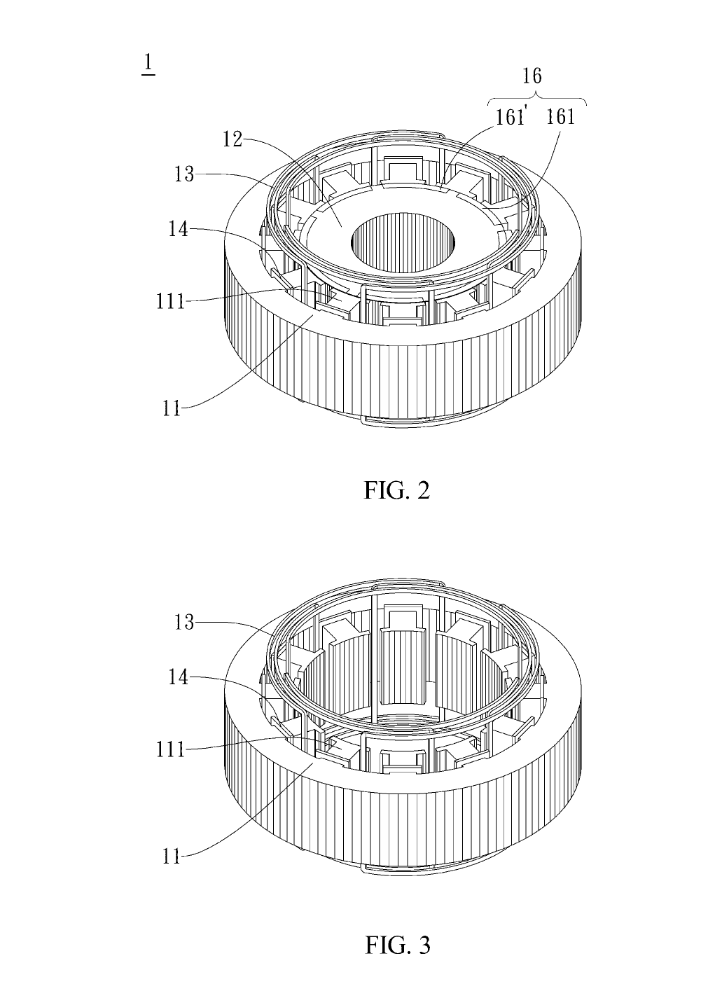

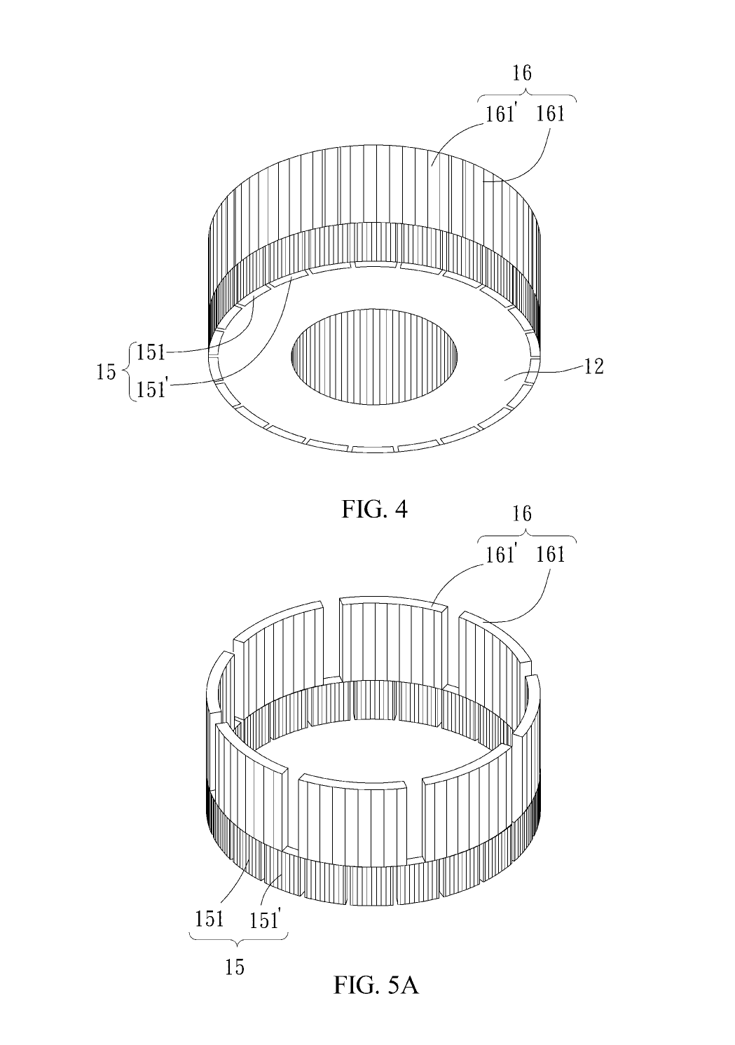

Please refer to FIG. 2, FIG. 3 and FIG. 4, which are the first schematic view, the second schematic view and the third schematic view of the first embodiment of the hybrid motor structure in accordance with the present invention. The embodiment realizes the concept of the hybrid motor structure of the present invention by a radial motor. As shown in FIG. 1, the hybrid radial motor 1 may include a stator 11, a rotor 12, a first coil 13, a first magnet set 15, a second coil 14 and a second magnet set 16.

As shown in FIG. 2, the stator 11 and the rotor 12 may be arranged in the radial direction of the hybrid radial motor 1. The stator 11 may include a plurality of stator teeth 111, and the stator teeth 111 may be disposed around the internal surface or external surface of the stator 11. In the embodiment, the stator 11 may be a combined stator; for high magnetic pole, the stator 11 may be assembled by the lamination of a plurality of silicon steel sheets, or be made of the soft-magnetic composite (SMC), or may include both of the lamination of the silicon steel steels and the soft-magnetic composite. As shown in FIG. 3, the first coil 13 and the second coil 14 may be wound on the stator teeth 111. As shown in FIG. 4, the first magnet set 15 may include a plurality of first magnet blocks 151, 151′; the first magnet blocks 151 and 151′ may be different magnetic poles; the first magnet blocks 151, 151′ may be corresponding to the first coil 13 to be disposed around the rotor 12, and spaced at regular interval or substantially spaced at regular interval, where the first magnet set 15 and the first coil 13 may form the first groove pole. In the embodiment, the first groove pole including the first magnet set 15 and the first coil 13 may feature high torque. The second magnet set 16 may include a plurality of second magnet blocks 161, 161′; the second magnet blocks 161 and 161′ may be different magnetic poles; the second magnet blocks 161, 161′ may be corresponding to the second coil 14 to be disposed around the rotor 12, and spaced at regular interval or substantially spaced at regular interval, where the second magnet set 16 and the second coil 14 may form the second groove pole, and the pole-pair number of the second coil 14 may be equal to the pole-pair number of the second magnet set 16. In the embodiment, the second groove pole including the second magnet set 16 and the second coil 14 may feature high power. However, the above structure is just for example instead of limitation; the present invention will not be limited by the above structure.

As described above, the hybrid radial motor 1 may have two groove poles with different characteristics; more specifically, the first groove pole may feature high torque, which is able to generate high torque when the motor 1 operates in low speed; on the contrary, the second groove pole may feature high power, which is able to provide high power when the motor 1 operates in high speed. Accordingly, when the hybrid radial motor 1 is in operation, the user can determine whether to simultaneously excite both of the first coil 13 and the second coil 14, or excite one of the first coil 13 and the second coil 14 according to the speed region of the motor 1 so as to generate different effects. For example, when the hybrid radial motor 1 operates in low speed, the use can excite both of the first coil 13 and the second coil 14 at the same time to increase the torque of the motor 1. On the contrary, when the hybrid radial motor 1 operates in high speed, the user only needs to keep exciting the second coil 14; however, if the user wants to increase the power of the motor 1, the user can excite the first coil 13 on a certain condition; for example, the current can be injected into the first coil 13 during low EMF. However, the above structure is just for example instead of limitation; the present invention will not be limited by the above structure.

Besides, the first coil 13 may further include a pole-changing structure (not shown in the drawings), and the pole-changing structure may include a plurality switch elements, and the pole-changing structure can change the pole number of the first coil via these switch elements. Similarly, the second coil 14 may also include a pole-changing structure (not shown in the drawings), and the pole-changing structure may include a plurality switch elements, and the pole-changing structure can change the pole number of the second coil via these switch elements. The details of the above pole-changing structure has been described in Taiwan patent Application No. 101129353, so will not be discussed herein.

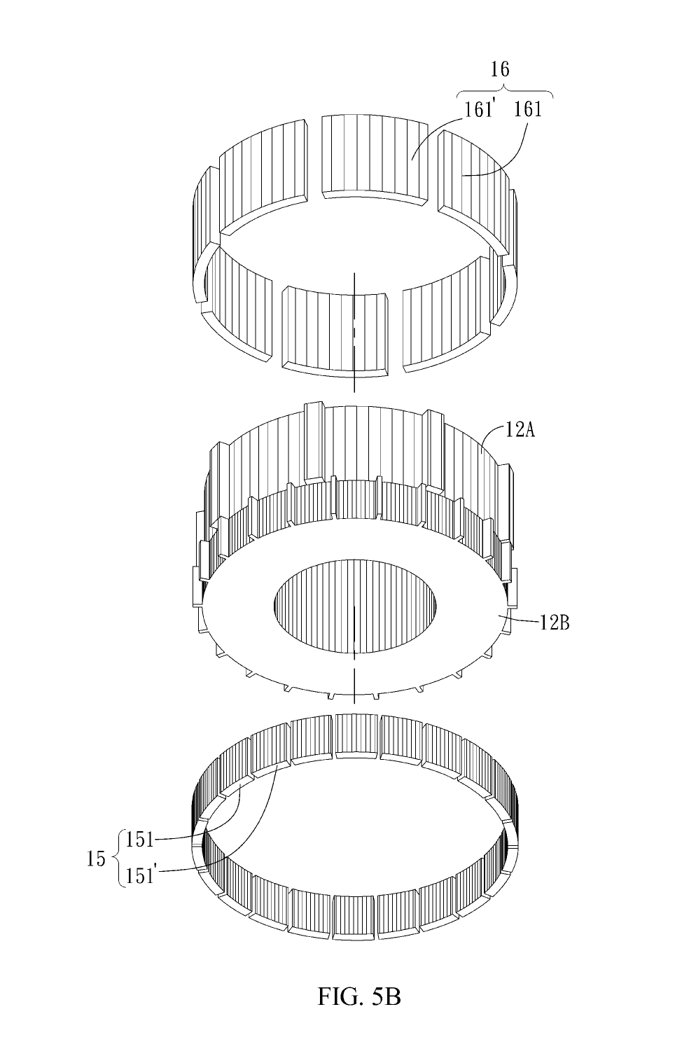

Please refer to FIG. 5A, which is the fourth schematic view of the first embodiment of the hybrid motor structure in accordance with the present invention. As shown in FIG. 5A, in the embodiment, two different magnet sets are simultaneously disposed on the rotor 12. More specifically, the first magnet set 15 may include a plurality of first magnet blocks 151, 151′; the first magnet blocks 151 and 151′ may be different magnetic poles; the first magnet blocks 151, 151′ may be disposed around the lower half of the rotor 12, and spaced at regular interval or substantially spaced at regular interval. The second magnet set 16 may include a plurality of second magnet blocks 161, 161′; the second magnet blocks 161 and 161′ may be different magnetic poles; the second magnet blocks 161, 161′ may be disposed around upper half of the rotor 12, and spaced at regular interval or substantially spaced at regular interval. However, the above structure is just for example instead of limitation; the present invention will not be limited by the above structure.

Please refer to FIG. 5B, which is the fifth schematic view of the first embodiment of the hybrid motor structure in accordance with the present invention. The design of the embodiment can also be applied to a motor structure with two rotors. As shown in FIG. 5B, the hybrid radial motor 1 may include an upper rotor 12A and a lower rotor 12B. The first magnet set 15 may include a plurality of first magnet blocks 151, 151′; the first magnet blocks 151 and 151′ may be different magnetic poles; the first magnet blocks 151, 151′ may be disposed around the upper rotor 12A, and spaced at regular interval or substantially spaced at regular interval. The second magnet set 16 may include a plurality of second magnet blocks 161, 161′; the second magnet blocks 161 and 161′ may be different magnetic poles; the second magnet blocks 161, 161′ may be disposed around upper half of the lower rotor 12B, and spaced at regular interval or substantially spaced at regular interval. In this way, the upper rotor 12A and the lower rotor 12B can independently operate and will not interfere with each other. However, the above structure is just for example instead of limitation; the present invention will not be limited by the above structure.

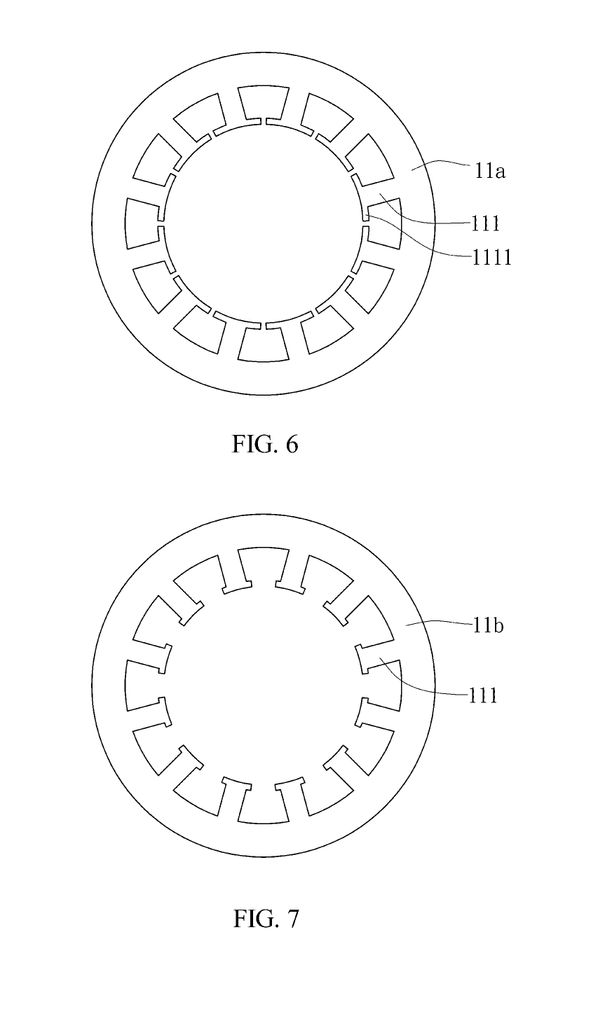

Please refer to FIG. 6 and FIG. 7, which are the sixth schematic view and the seventh schematic view of the first embodiment of the hybrid motor structure in accordance with the present invention; FIG. 6 and FIG. 7 shows the cross-sectional view of the stator of the embodiment.

In the embodiment, two different coils are wound on the stator teeth 111 of the stator 11, so the stator 11 can have different designs according to different applications. As shown in FIG. 6 and FIG. 7, the stator 11 may consist of an upper stator component 11a and a lower stator component 11b. The upper stator component 11a may be corresponding to the second magnet set 16, and the stator teeth 111 of the upper stator component 11a may have tooth shoes 1111, which are corresponding to the second magnet set 16. On the contrary, as shown in FIG. 7, the lower stator component 11b may be corresponding to the first magnet set 15, and the stator teeth 111 of the lower stator component 11b may have no tooth shoes. However, the above structure is just for example instead of limitation; the present invention will not be limited by the above structure.

Besides, the structure of the coils may vary with the structure of the magnet sets to cover the corresponding magnet sets.

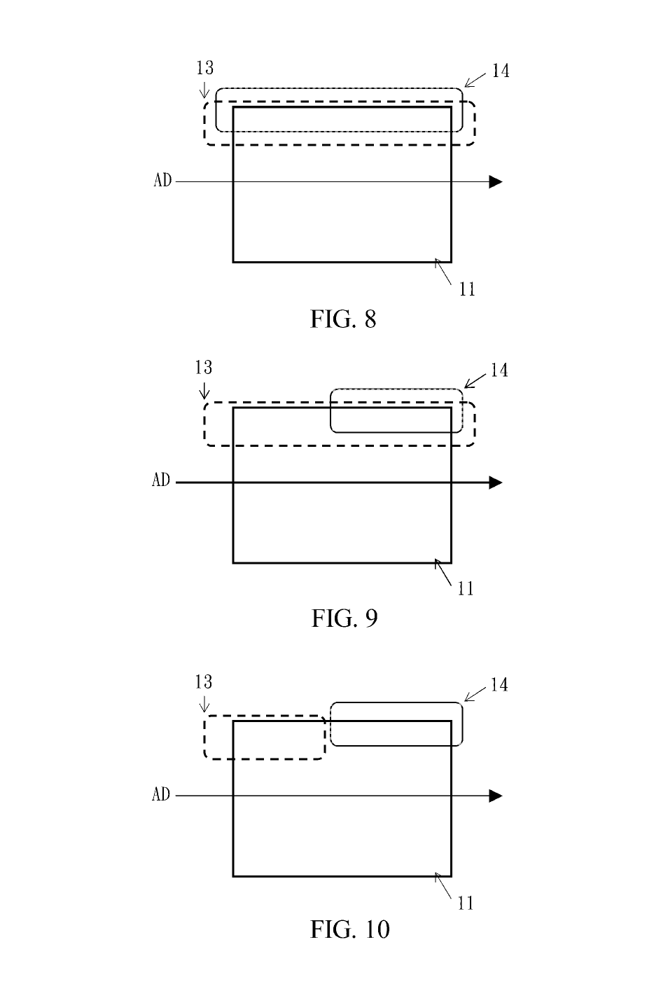

Please refer to FIG. 8, FIG. 9 and FIG. 10, which are the eighth schematic view, the ninth schematic view and tenth schematic view of the first embodiment of the hybrid motor structure in accordance with the present invention. As shown in FIG. 8, from the serial direction AD to perceive, both of the installation range of the first coil 13 and the installation range of the second coil 14 may cover the coil installation area of the stator 11. In another embodiment, as shown in FIG. 9, from the serial direction AD to perceive, the installation range of the first coil 13 may cover the coil installation area of the stator 11, but the installation range of the second coil 14 may not cover the coil installation area of the stator 11. In a further embodiment, the installation range of the second coil 14 may cover the coil installation area of the stator 11, but the installation range of the first coil 13 may not cover the coil installation area of the stator 11. In a still further embodiment, as shown in FIG. 10, from the serial direction AD to perceive, both of the installation range of the first coil 13 and the installation range of the second coil 14 may not cover the coil installation area of the stator 11. However, the above structure is just for example instead of limitation; the present invention will not be limited by the above structure.

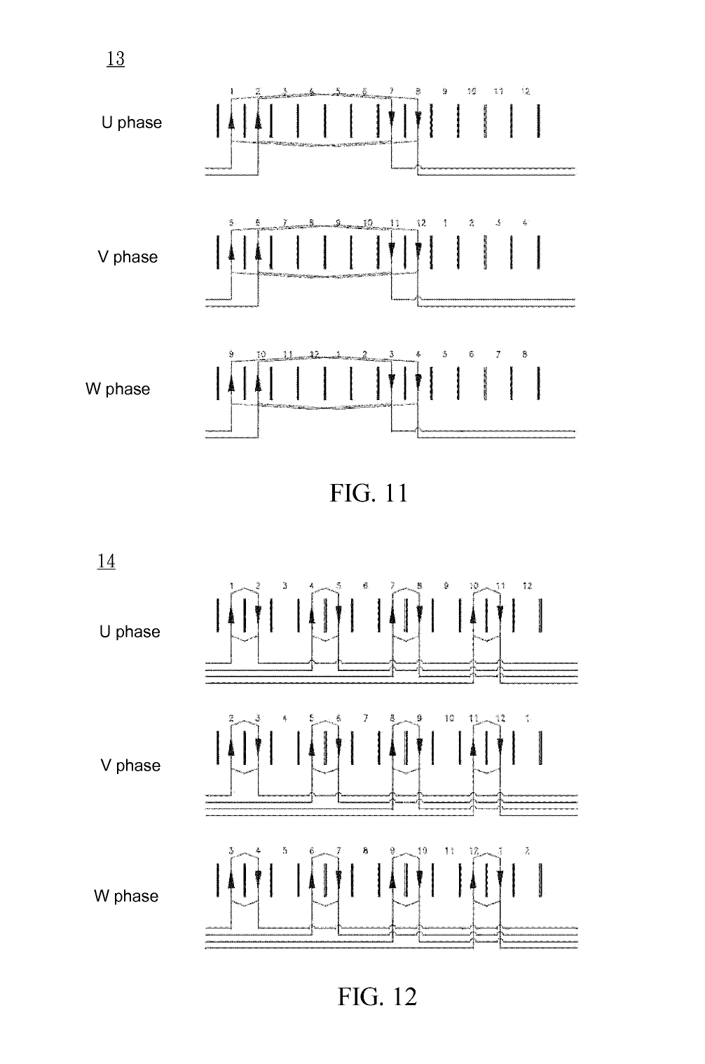

Please refer to FIG. 11 and FIG. 12, which are the eleventh schematic view and twelfth schematic view of the first embodiment of the hybrid motor structure in accordance with the present invention; FIG. 11 and FIG. 12 illustrate windings of the U-phase coil, V-phase coil and W-phase coil of the hybrid motor structure of the embodiment.

As the stator of the hybrid motor of the embodiment may include several coils, it is an important issue to minimize the magnetic flux linkage between these coils via proper magnetic pole relation; in this way, the independence of the hybrid motor can be higher when the hybrid motor is in operation. In other words, all of the U-phase coil, V-phase coil and W-phase coil of the hybrid motor can be independently controlled to more accurately control the hybrid motor.

FIG. 11 illustrates the windings of the U-phase coil, V-phase coil and W-phase coil of the first coil 13, wherein its pole-pair number is 1; FIG. 12 illustrates the windings of the U-phase coil, V-phase coil and W-phase coil of the second coil 14, wherein its pole-pair number is 4; therefore, the pole-pair number of the second coil 14 is 4 times of the pole-pair number of the first coil 13.

That is to say, when the pole-pair number of the first coil 13 is 1, the pole-pair number of the second coil 14 may be integer multiple of the pole-pair number of the first coil 13, and the integer multiple may be greater than 1, as shown in the following equations:

The pole-pair number of the first coil 13=1;

The pole-pair number of the second coil 14=n(n>1);

In the embodiment, the sum of the pole-pair number of the first coil 13 and the pole-pair number of the second coil 14 may be equal to the quantity of the stator teeth 111 of the stator 11; in this way, the magnetic flux linkage between different coils can be effectively decreased.

In another embodiment, the pole-pair number of the first coil 13 may be greater than 1; similarly, the pole-pair number of the second coil 14 may be integer multiple of the pole-pair number of the first foil 13, as shown in the following equations:

The pole-pair number of the first coil 13=q(q>1);

The pole-pair number of the second coil 14=nq(n>1);

In other embodiments, the pole-pair number of the first coil 13 and the pole-pair number of the second coil 14 may have different structures; the present invention will not be limited by the above structures.

By means of the above structure, the magnetic flux linkage between the several coils of the hybrid motor structure can be reduced, so the independence of the hybrid motor can increase when the hybrid motor operates in order to accurately control the hybrid motor and better the performance of the hybrid motor. However, the above structures are just for example instead of limitation; the present invention will not be limited by the above structures.

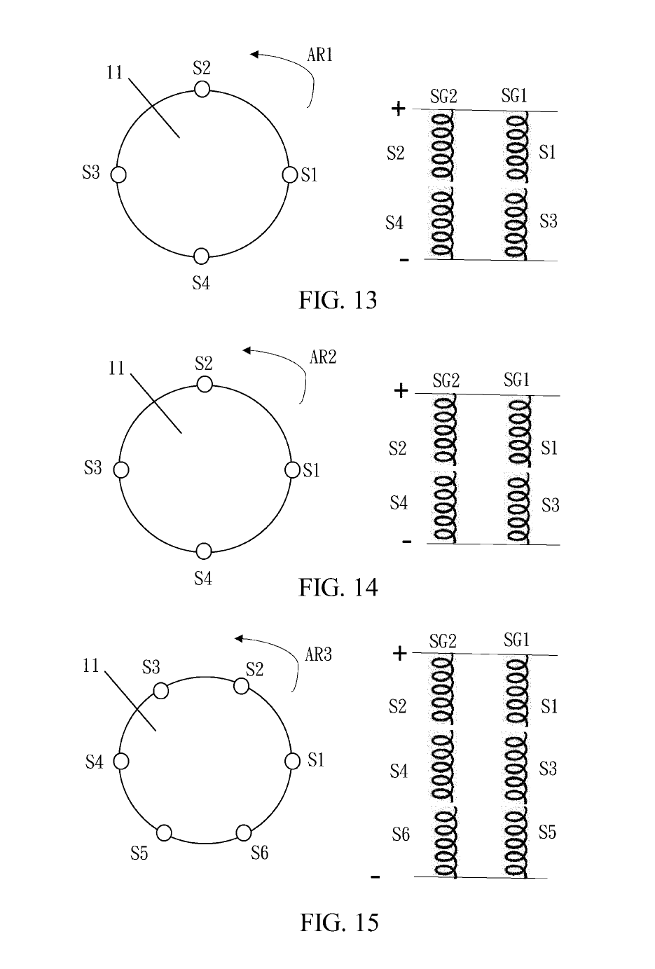

Please refer to FIG. 13, FIG. 14 and FIG. 15, which are the thirteenth schematic view, the fourteenth schematic view and fifteenth schematic view of the first embodiment of the hybrid motor structure in accordance with the present invention; FIG. 13, FIG. 14 and FIG. 15 illustrate several proper coil structures for the embodiment.

As described above, for the purpose of keeping good independence of the hybrid motor when the hybrid motor is in operation, it is very important to minimize the magnetic flux linage between the coils of the hybrid motor; in this way, all of the U-phase coil, V-phase and W-phase coil can be controlled to more accurately control the hybrid motor. In the embodiment, the special connection design of the sub-coils can further decrease the magnetic flux linkage of the coils of the hybrid motor; the embodiment illustrates several proper connection designs.

As shown in FIG. 13, the pole-pair number of the first coil 13 is 1 and the pole-pair number of the second coil 14 is 4; the second coil 14 may be a three-phase coil, including U-phase coil, V-phase and W-phase coil. The embodiment takes the U-phase coil of the second coil 14 as an example, which may include a plurality of sub-coils S1-S4 and these sub-coils S1-S4 may be wound on the stator 11. Any one of the sub-coil may be connected to the sub-coil at the opposite side in series to form a sub-coil set; therefore, the second coil 14 may include a plurality of sub-coil sets SG1-SG2 and the sub-coil sets SG1-SG2 may be connected in parallel. As shown in FIG. 13, the second coil 14 may include four sub-coils S1-S4; the sub-coil S1 may be connected to the sub-coil S3 at the opposite side in series to form the sub-coil set SG1; the sub-coil S2 may be connected to the sub-coil S4 at the opposite side in series to form the sub-coil set SG2; the sub-coil set SG1 and the sub-coil SG2 may be connected in parallel. The arrow AR1 shown in FIG. 13 means 0-360° of the mechanical angle of the periphery of the stator 11. In another embodiment, the sub-coil set SG1 and the sub-coil set SG2 may be connected in series. In a further embodiment, the sub-coils S1, S3 may be connected in parallel, and the sub-coils S2, S4 may also be connected in parallel.

In a still further embodiment, the pole-pair number of the first coil 13 may be equal to q (q is an integer greater than 1) and the pole-pair number of the second coil 14 may be nq (n is an integer greater than 1). As shown in FIG. 14, the pole-pair number of the first coil 13 is q (q is an integer greater than 1) and the pole-pair number of the second coil 14 may be 4q; the second coil 14 may be a three-phase coil, including U-phase coil, V-phase coil and W-phase coil. The embodiment takes the U-phase coil of the second coil 14 as an example, which may include a plurality of sub-coils S1-S4 and the sub-coils S1-S4 may be wound on the stator 11. Any one of the sub-coil may be connected to the sub-coil at the opposite side in parallel to form a sub-coil set; therefore, the second coil 14 may include a plurality of sub-coil sets SG1-SG2 and the sub-coil sets SG1-SG2 may be connected in parallel. As shown in FIG. 14, the second coil 14 may include four sub-coils S1-S4; the sub-coil S1 may be connected to the sub-coil S3 at the opposite side in series to form the sub-coil set SG1; the sub-coil S2 may be connected to the sub-coil S4 at the opposite side in series to form the sub-coil set SG2; the sub-coil set SG1 and the sub-coil SG2 may be connected in series. The difference between the embodiment and the previous embodiment is that the arrow AR2 around the periphery of the stator 11 shown in FIG. 14 means 0-360° of the electrical angle of the magnetic field of the first coil 13.

As shown in FIG. 15, the pole-pair number of the first coil 13 is 1 and the pole-pair number of the second coil 14 may be 6; the second coil 14 may be a three-phase coil, including U-phase coil, V-phase coil and W-phase coil. The embodiment takes the U-phase coil of the second coil 14 as an example, which may include a plurality of sub-coils S1-S6 and the sub-coils S1-S6 may be wound on the stator 11. Therefore, the second coil 14 may include a plurality of sub-coil sets SG1-SG2 and the sub-coil sets SG1-SG2 may be connected in parallel; the pole-pair number of the second coil 14 may be integer multiple of the quantity of the sub-coils of each of the sub-coil sets SG1-SG2. As shown in FIG. 15, the second coil 14 may include six sub-coils S1-S6 to form two sub-coil sets SG1-SG2; the sub-coil S1, sub-coil S3 and the sub-coil S5 may be connected in series to form the sub-coil set SG1; the sub-coil S2, sub-coil S4 and the sub-coil S6 may be connected in series to form the sub-coil set SG2; the sub-coil set SG1 and the sub-coil SG2 may be connected in parallel. The arrow AR3 shown in FIG. 14 means 0-360° of the mechanical angle of the periphery of the stator 11. In another embodiment, the sub-coil set SG1 and the sub-coil set SG2 may be connected in series. In a further embodiment, the sub-coils S1, S3, S5 may be connected in parallel, and the sub-coils S2, S4, S6 may also be connected in parallel.

By means of the above structures, the magnetic flux linage between the first coil 13 and the second coil 14 may be minimized; accordingly, the independence of the hybrid motor can be higher to more accurately control the hybrid motor and better the performance of the hybrid motor.

To sum up, for the purpose of keeping high independence of the hybrid motor and accurately controlling the hybrid motor, the embodiment provides a connection principle to achieve the above objects. If the pole-pair number of the first coil 13 is 1 and the quantity of the sub-coils of the second coil 14 is n (n>1), there will be at least s kinds of serial connection methods, where s may be equal to the quantity of the factors of n except for 1; the set of the factor is A={n₁, n₂. . . nₛ}. For instance, when n=4, n₁=4, n₂=2 and s=2. If nᵢ=k, the k sub-coils should be uniformly distributed around the periphery of the stator 11, which may be around 0-360° of the of the mechanical angle of the periphery of the stator 11, or 0-360° of the electrical angle of the magnetic field of the first coil 13. Besides, the k sub-coils may be divided into several sub-coil sets and each of the sub-coil sets may include several sub-coils connected in series, and the sub-coil sets may be connected in parallel or in series.

If the pole-pair number of the first coil 13 is q, q is greater than 1 and the quantity of the sub-coils of the second coil 14 is nq (n>1), there will be at least s kinds of serial connection methods, where s may be equal to the quantity of the factors of n except for 1; the set of the factor is A={n₁, n₂, . . . nₛ}. For instance, when n=4, n₁=4, n₂=2 and s=2. If nᵢ=k, the k sub-coils should be uniformly distributed around 0-360° of the electrical angle of the magnetic field of the first coil 13 of the stator 11. Besides, the k sub-coils may be divided into several sub-coil sets and each of the sub-coil sets may include several sub-coils connected in series, and the sub-coil sets may be connected in parallel or in series.

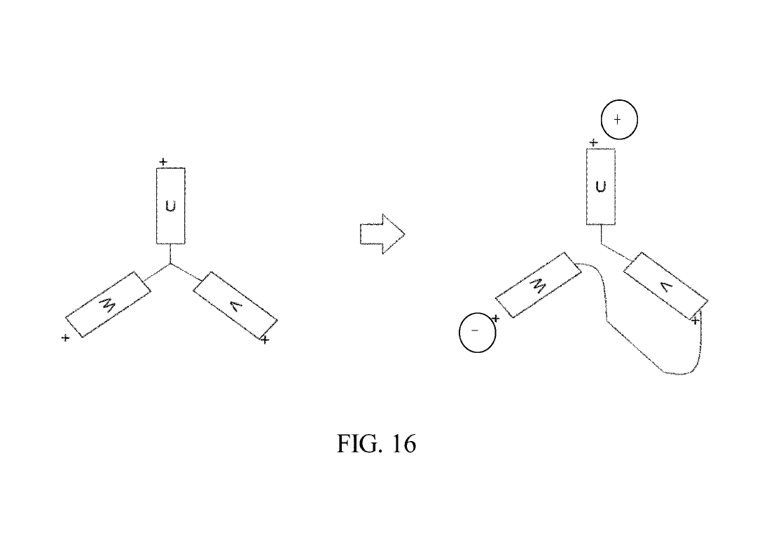

Please refer to FIG. 16, which is the sixteenth schematic view of the first embodiment of the hybrid motor structure in accordance with the present invention; FIG. 16 illustrates the schematic view of the first coil 13 of the embodiment; in the embodiment, the object of the first coil 13 is to increase the torque.

As shown in FIG. 16, for the purpose of decreasing the cost and the complexity of the power module of the hybrid radial motor 1, the first coil 13 may a single-phase coil. FIG. 16 illustrates the structure changed from the three-phase coil to the single-phase coil. The original three-phase coil is at the left side of FIG. 13 and “+” stands for the direction where the current is inputted; the three-phase connection is at the right side of FIG. 13, and the connection method is: the current flows into the “+” end of the U-phase and flows into the “−” end of the V-phase and then flows into the “−” end of the W-phase. The “+” end and the “−” end of the new single-phase coil are marked by the black circles.

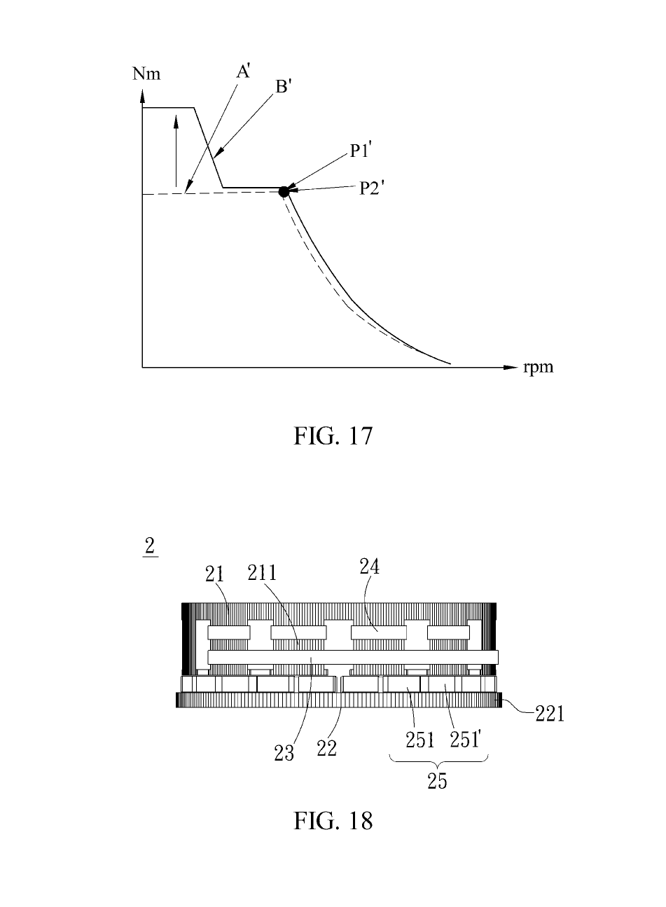

Please refer to FIG. 17, which is the seventeenth schematic view of the first embodiment of the hybrid motor structure in accordance with the present invention; FIG. 17 illustrates the schematic view of the power output characteristics of the hybrid motor structure of the embodiment.

The embodiment realizes the concept of the present invention via a hybrid motor, so the hybrid motor can achieve the power output characteristics shown in FIG. 17. As shown in FIG. 17, the overall power can be almost constant; in other words, the maximum power point P1′ of the curve A′ is almost equal to the maximum power point of P2′ of the curve B′. Accordingly, if the torque of the curve B′ (low-speed region) should be increased, only local power should be increased, so it is not necessary to significantly increase the weight and the size of the hybrid motor. Moreover, the hybrid motor structure of the embodiment can use the magnetic pole to increase its torque in the low-speed region instead of increasing the voltage; thus, the efficiency of the hybrid motor can be very high. Therefore, the hybrid motor is very suitable for in-wheel motor of electric motor, integrated starter generator (ISG) or other applications with high requirements in space and weight.

It is worthy to point out that since the conventional motors are limited by their designs, so the conventional motors cannot achieve high torque in low speed and wide speed region because the conventional motors are limited by their size and weight. On the contrary, according to one embodiment of the present invention, the stator of the hybrid motor may be installed with multiple coils and the stator of the hybrid motor may be installed with multiple magnet sets so as to provide multiple groove poles with various characteristics, such as high torque, high power and the like. Accordingly, the hybrid motor can have special power output characteristics, so it can achieve high torque in low speed and wide speed region even if its size and weight are limited.

In addition, one embodiment of the present invention further provides different designs about pole-pair number and different sub-coil structures so as to minimize the magnetic flux linage between multiple coils; thus, these coils will not interfere with each other. In this way, the independence of the hybrid motor can be maintained when the hybrid motor operates so as to more accurately control the hybrid motor and optimize its performance.

Also, since the conventional motors are limited by their designs, they need two stators and two rotors to achieve high torque in low speed and wide speed region. On the contrary, according to one embodiment of the present invention, the hybrid motor can achieve the high torque in low speed and wide speed region by one rotor and one stator, so the hybrid motor can be of low weight, small size and low cost. Furthermore, according to one embodiment of the present invention, the hybrid motor does not need to completely use the flux-weakening control to increase it speed region, so the hybrid motor can be of high efficiency and high speed region extension. Accordingly, the present invention definitely has an inventive step.

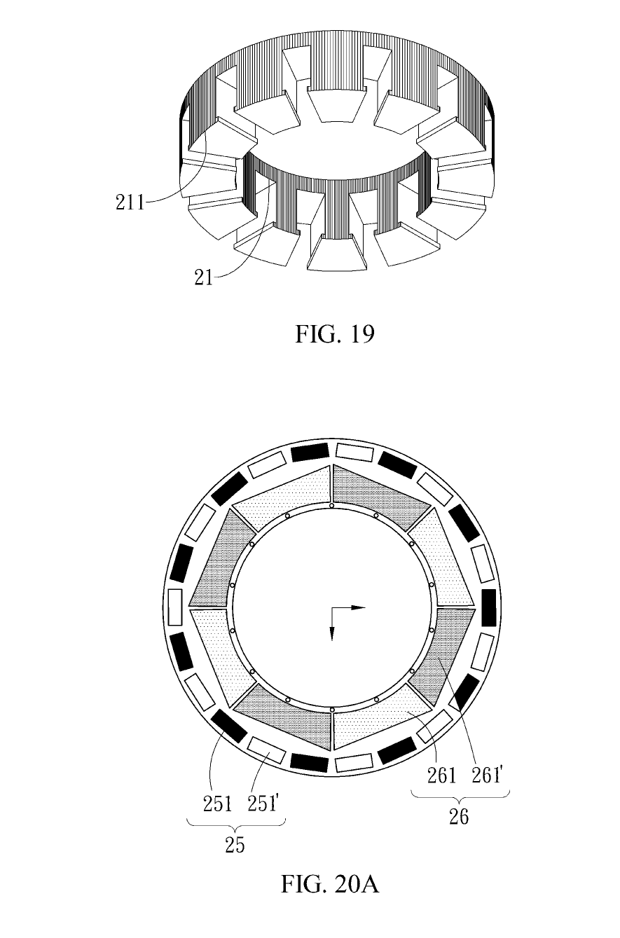

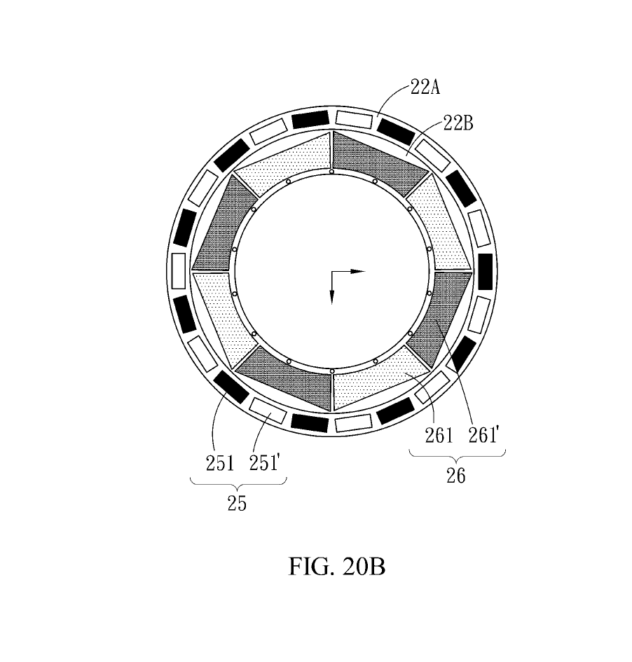

Please refer to FIG. 18, FIG. 19 and FIG. 20A, which are the first schematic view, the second schematic view and the third schematic view of the second embodiment of the hybrid motor structure in accordance with the present invention. The embodiment realizes the concept of the hybrid motor structure of the present invention by a serial motor. As shown in FIG. 18, the hybrid serial motor 2 may include a stator 21, a rotor 22, a first coil 23, a first magnet set 25, a second coil 24 and a second magnet set 26.

As shown in FIG. 18, the stator 21 and the rotor 22 may be arranged in the serial direction of the hybrid serial motor 2. As shown in FIG. 19, the stator 21 may include a plurality of stator teeth 211, and the stator teeth 211 may be disposed on the lower surface of the stator 21 and toward the rotor 22. In the embodiment, the stator 21 may be a combined stator; for high magnetic pole, the stator 21 may be assembled by the lamination of a plurality of silicon steel sheets, or be made of the soft-magnetic composite (SMC), or may include both of the lamination of the silicon steel steels and the soft-magnetic composite. As shown in FIG. 18, the first coil 23 and the second coil 24 may be wound on the stator teeth 211. As shown in FIG. 20A, the first magnet set 25 may include a plurality of first magnet blocks 251, 251′; the first magnet blocks 251 and 251′ may be different magnetic poles. From the radial direction of the hybrid serial motor 2 to perceive, the first magnet blocks 251, 251′ may be disposed around the external side of the rotor back iron and corresponding to the first coil 23, where the first magnet set 25 and the first coil 23 may form the first groove pole; in the embodiment, the first groove pole including the first magnet set 25 and the first coil 23 may feature high torque. The second magnet set 26 may include a plurality of second magnet blocks 261, 261′; the second magnet blocks 261 and 261′ may be different magnetic poles. From the radial direction of the hybrid serial motor 2 to perceive, the second magnet blocks 261, 261′ may be disposed around the internal side of the rotor back iron and corresponding to the second coil 24, where the second magnet set 26 and the second coil 24 may form the second groove pole; in the embodiment, the second groove pole including the second magnet set 26 and the second coil 24 may feature high power. However, the above structure is just for example instead of limitation; for instance, from the radial direction of the hybrid serial motor 2 to perceive, the first magnet set 25 may be disposed around the internal side of the rotor back iron 221, and the second magnet set 26 may be disposed around the external side of the rotor back iron 221.

Besides, the first coil 23 may further include a pole-changing structure (not shown in the drawings), and the pole-changing structure may include a plurality switch elements, and the pole-changing structure can change the pole number of the first coil via these switch elements. Similarly, the second coil 24 may also include a pole-changing structure (not shown in the drawings), and the pole-changing structure may include a plurality switch elements, and the pole-changing structure can change the pole number of the second coil via these switch elements.

As described above, the hybrid serial motor 2 may also have two groove poles with different characteristics; more specifically, the first groove pole may feature high torque, which is able to generate high torque when the motor 2 operates in low speed; on the contrary, the second groove pole may feature high power, which is able to provide high power when the motor 2 operates in high speed. Accordingly, when the hybrid serial motor 2 is in operation, the user can determine whether to simultaneously excite both of the first coil 23 and the second coil 24, or excite one of the first coil 23 and the second coil 24 according to the speed region of the motor 2 so as to generate different effects. For example, when the hybrid serial motor 2 operates in low speed, the use can excite both of the first coil 23 and the second coil 24 at the same time to increase the torque of the motor 2. On the contrary, when the hybrid serial motor 2 operates in high speed, the user only needs to keep exciting the second coil 24; however, if the user wants to increase the power of the motor 2, the user can excite the first coil 23 on a certain condition; for example, the current can be injected into the first coil 23 during low EMF. However, the above structure is just for example instead of limitation; the present invention will not be limited by the above structure.

Similarly, the structure of the coils may vary with the structure of the magnet sets to cover the corresponding magnet sets.

Please refer to FIG. 20B, which is the fourth schematic view of the second embodiment of the hybrid motor structure in accordance with the present invention. The design of the embodiment can also be applied to a motor structure with two rotors. As shown in FIG. 20B, the hybrid serial motor 2 may include an inner rotor 22A and an outer rotor 22B. The first magnet set 25 may include a plurality of first magnet blocks 251, 251′; the first magnet blocks 251 and 251′ may be different magnetic poles. From the radial direction of the hybrid serial motor 2 to perceive, the first magnet blocks 251, 251′ may be disposed around the rotor back iron of the outer rotor 22A and corresponding to the first coil 23. The second magnet set 26 may include a plurality of second magnet blocks 261, 261′; the second magnet blocks 261 and 261′ may be different magnetic poles. From the radial direction of the hybrid serial motor 2 to perceive, the second magnet blocks 261, 261′ may be disposed around the rotor back iron of the inner rotor 22B and corresponding to the second coil 24. In this way, the outer rotor 22A and the inner rotor 22B can independently operate and will not interfere with each other. However, the above structure is just for example instead of limitation; the present invention will not be limited by the above structure.

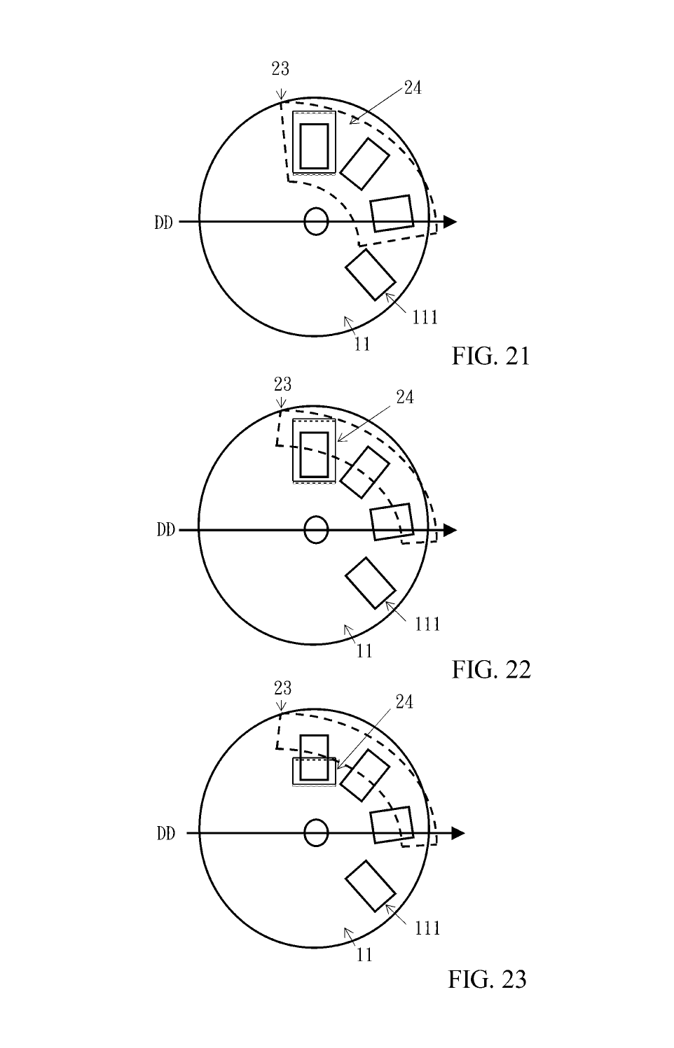

Please refer to FIG. 21, FIG. 22 and FIG. 23, which are the fifth schematic view, the sixth schematic view and the seventh schematic view of the second embodiment of the hybrid motor structure in accordance with the present invention. As shown in FIG. 21, from the radial direction DD to perceive, both of the installation range of the first coil 23 and the installation range of the second coil 24 may cover the coil installation area of the stator 21. In another embodiment, as shown in FIG. 22, from the radial direction AD to perceive, the installation range of the second coil 24 may cover the coil installation area of the stator 21, but the installation range of the first coil 23 may not cover the coil installation area of the stator 21. In a further embodiment, the installation range of the first coil 23 may cover the coil installation area of the stator 21, but the installation range of the second coil 24 may not cover the coil installation area of the stator 11. In a still further embodiment, as shown in FIG. 23, from the serial direction DD to perceive, both of the installation range of the first coil 23 and the installation range of the second coil 24 may not cover the coil installation area of the stator 21. However, the above structure is just for example instead of limitation; the present invention will not be limited by the above structure.

Similarly, the embodiment may also, just like the previous embodiment, use appropriate magnetic pole relations to minimize the magnetic flux linkage between multiple coils so as to keep high independence of the hybrid motor and accurately control the hybrid motor; thus, the first coil 23 and the second coil 24 of the hybrid serial motor 2 may also have special pole-pair number relations and the sub-coils may also have specific serial/parallel connection relations; however, which has been described in the first embedment and will not be repeated herein.

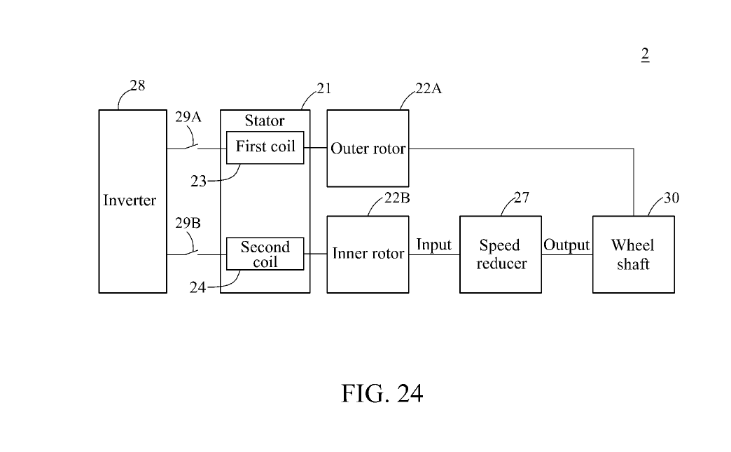

Please refer to FIG. 24, which is the schematic view of the third embodiment of the hybrid motor structure in accordance with the present invention. The embodiment realizes the concept of the hybrid motor structure of the present invention by a serial motor. As shown in FIG. 24, the hybrid motor structure 2 may include a stator 21, an outer rotor 22A, an inner rotor 22B, a first coil 23, a second coil 24, a speed reducer 27, an inverter 28, and switches 29A, 29B.

The first coil 23 and the second coil 24 may be wound on the stator 21. The inverter 28 may be coupled to the first coil 23 via the switch 29A, and coupled to the second coil 24 via the switch 29B so as to drive the outer rotor 22A and the inner rotor 22B respectively. The outer rotor 22A may be coupled to the wheel shaft 30; the inner rotor 22B may be coupled to the input of the speed reducer 27, and the output of the speed reducer 27 may be coupled to the wheel shaft 30.

If the rotation speed of the wheel shaft 18 is W, and the pole-pair number of the magnet set of the inner rotor 22B is 4 times the pole-pair number of the magnet set of the outer rotor 22A, the change rate of the electrical angle of the inner rotor 22B will also be 4 times the change rate of the electrical angle of the outer rotor 22A. Thus, for the purpose of making the phase of the counter-electromotive force of the three-phase coil of the outer rotor 22A be the same with that of the inner rotor 22B when the outer rotor 22A and the inner rotor 22B are driven by the same inverter 28, the reduction ratio of the speed reducer 15 may be designed to be 1:4; in other words, the ratio value of the reduction ratio of the speed reducer 15 may be equal to the ratio value of the pole-pair number of the magnet set of the outer rotor 22A to the pole-pair number of the magnet set of the inner rotor 22B.

When the rotation speed W of the wheel shaft 30 increases to a certain speed, the outer rotor 22A may be asynchronous with the inner rotor 22B; at this time, one of the outer rotor 22A and the inner rotor 22B may be selectively disconnected from the inverter 16 via the switches 29A, 29B; in this way, the hybrid motor structure 2 can stably operate.

Via the above design, the hybrid motor structure 2 can make the outer rotor 22A and the inner rotor 22B be synchronous; therefore, the volume, weight, and cost of the hybrid motor structure 2; moreover, the above design can also allow the hybrid motor structure 2 to have more dynamic characteristics, so the application of the hybrid motor structure 2 can be more comprehensive. However, the embodiment is just an example; the above design can also be realized by a radial motor or other different motor structures.

In summation of the description above, the hybrid motor structure in accordance with the embodiments of the present invention may have the following advantages:

(1) According to one embodiment of the present invention, the stator of the hybrid motor may be installed with multiple coils and the stator of the hybrid motor may be installed with multiple magnet sets so as to provide multiple groove poles with various characteristics, such as high torque, high power and the like. Accordingly, the hybrid motor can have special power output characteristics, so it can achieve high torque in low speed and wide speed region even if it size and weight are limited.

(2) According to one embodiment of the present invention, the hybrid motor may use special coil structure to minimize the magnetic flux linkage between multiple coils, so each of these coils can be driven independently without any difficulties; accordingly, these coils will not interfere with each other, so the performance of the hybrid motor can be optimized.

(3) According to one embodiment of the present invention, the hybrid motor does not need to completely use the flux-weakening control to increase it speed region, so the hybrid motor can be of high efficiency and high speed region extension.

(4) According to one embodiment of the present invention, the hybrid motor can be realized by one rotor and one stator, so the hybrid motor can be of low weight, small size and low cost.

(5) According to one embodiment of the present invention, the hybrid motor can achieve high torque in low speed without increasing overall power, so the hybrid motor can still achieve high performance even if limited by space and weight. Therefore, the hybrid motor is very suitable for in-wheel motor of electric motor, integrated starter generator (ISG) or other applications with high requirements in space and weight.

(6) According to one embodiment of the present invention, the hybrid motor structure is applicable to various kinds of motors, such as radial motor, serial motor and the like; therefore, the application of the hybrid motor structure is very comprehensive.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A hybrid motor structure, comprising:
a rotor;
a stator, comprising a plurality of stator teeth, wherein the rotor and the stator are arranged in a radial direction of the hybrid motor structure;
a first coil, being wound on the stator teeth;
a first magnet set, comprising a plurality of first magnet blocks, wherein the first magnet blocks are disposed around the rotor and corresponding to the first coil; the first magnet set and the first coil form a first groove pole;
a second coil, being wound on the stator teeth; and
a second magnet set, comprising a plurality of second magnet blocks, wherein the second magnet blocks are disposed around the rotor and corresponding to the second coil; the second magnet set and the second coil form a second groove pole.

2. The hybrid motor structure of claim 1, wherein the stator teeth are disposed around an internal surface or an external surface of the stator.

3. The hybrid motor structure of claim 1, wherein a pole-pair number of the first coil is 1; a pole-pair number of the second coil is an integer multiple of the pole-pair number of the first coil, and the integer multiple is greater than 1.

4. The hybrid motor structure of claim 1, wherein a pole-pair number of the first coil is greater than 1; a pole-pair number of the second coil is an integer multiple of the pole-pair number of the first coil, and the integer multiple is greater than 1.

5. The hybrid motor structure of claim 1, wherein a pole-pair number of the second coil is equal to a pole-pair number of the second magnet set.

6. The hybrid motor structure of claim 3, wherein a sum of the pole-pair number of the first coil and a pole-pair number of the first magnet set is equal to a number of the stator teeth.

7. The hybrid motor structure of claim 4, wherein a sum of the pole-pair number of the first coil and a pole-pair number of the first magnet set is equal to a number of the stator teeth.

8. The hybrid motor structure of claim 5, wherein a sum of a pole-pair number of the first coil and a pole-pair number of the first magnet set is equal to a number of the stator teeth.

9. The hybrid motor structure of claim 1, wherein the second coil comprises a plurality of sub-coils, and the sub-coils are wound on the stator teeth and connected in series.

10. The hybrid motor structure of claim 1, wherein the second coil comprises a plurality of sub-coils, and the sub-coils are wound on the stator teeth; any one of the sub-coils is connected to the sub-coil at an opposite side in series to form a sub-coil set; the second coil comprises a plurality of the sub-coil sets.

11. The hybrid motor structure of claim 10, wherein the sub-coil sets are connected in series.

12. The hybrid motor structure of claim 10, wherein the sub-coil sets are connected in parallel.

13. The hybrid motor structure of claim 3, wherein the second coil comprises a plurality of sub-coil sets, and each of the sub-coil sets comprises a plurality of sub-coils; the sub-coils are wound on the stator teeth, and the sub-coils of each of the sub-coil sets are connected in series or in parallel; the sub-coil sets are connected to each other/one another.

14. The hybrid motor structure of claim 13, wherein a quantity of the sub-coils of each of the sub-coil sets is equal to a factor of the pole-pair number of the second coil, and the factor is greater than 1.

15. The hybrid motor structure of claim 14, wherein the sub-coils of each sub-coil set are spaced at regular interval or substantially spaced at regular interval and disposed around 0-360° of a mechanical angle of a periphery of the stator, or 0-360° of an electrical angle of a magnetic field of the first coil.

16. The hybrid motor structure of claim 4, wherein the second coil comprises a plurality of sub-coil sets, and each of the sub-coil sets comprises a plurality of sub-coils wound around the stator teeth; the sub-coils of each of the sub-coil sets are connected in series or in parallel and the sub-coil sets are connected to each other/one another.

17. The hybrid motor structure of claim 16, wherein a quantity of the sub-coils of each of the sub-coil sets is equal to a factor of the pole-pair number of the second coil, and the factor is greater than 1.

18. The hybrid motor structure of claim 17, wherein the sub-coils of each sub-coil set are spaced at regular interval or substantially spaced at regular interval and disposed around 0-360° of an electrical angle of a magnetic field of the first coil.

19. The hybrid motor structure of claim 13, wherein the sub-coil sets are connected in series.

20. The hybrid motor structure of claim 13, wherein the sub-coil sets are connected in parallel.

21. The hybrid motor structure of claim 16, wherein the sub-coil sets are connected in series.

22. The hybrid motor structure of claim 16, wherein the sub-coil sets are connected in parallel.

23. The hybrid motor structure of claim 19, wherein the pole-pair number of the second coil is an integer multiple of a quantity of the sub-coils of each of the sub-coil sets.

24. The hybrid motor structure of claim 20, wherein the pole-pair number of the second coil is an integer multiple of a quantity of the sub-coils of each of the sub-coil sets.

25. The hybrid motor structure of claim 21, wherein the pole-pair number of the second coil is an integer multiple of a quantity of the sub-coils of each of the sub-coil sets.

26. The hybrid motor structure of claim 22, wherein the pole-pair number of the second coil is an integer multiple of a quantity of the sub-coils of each of the sub-coil sets.

27. The hybrid motor structure of claim 1, wherein from a serial direction of the hybrid motor structure to perceive, both of an installation range of the first coil and an installation range of the second coil cover a coil installation area of the stator.

28. The hybrid motor structure of claim 1, wherein from a serial direction of the hybrid motor structure to perceive, an installation range of the second coil covers a coil installation area of the stator, but an installation range of the first coil fails to cover the coil installation area of the stator.

29. The hybrid motor structure of claim 1, wherein from a serial direction of the hybrid motor structure to perceive, both of an installation range of the first coil and an installation range of the second coil fail to cover a coil installation area of the stator.

30. The hybrid motor structure of claim 1, wherein the stator is assembled by a lamination of a plurality of silicon steel sheets, or made of a soft-magnetic composite, or comprises both of the lamination of the silicon steel steels and the soft-magnetic composite.

31. The hybrid motor structure of claim 1, wherein the rotor comprises an upper rotor and a lower rotor; the first magnet blocks are disposed around the upper rotor and corresponding to the first coil and the second magnet blocks are disposed around the lower rotor and corresponding to the second coil.

32. The hybrid motor structure of claim 31, further comprising a speed reducer and an inverter, wherein the inverter is coupled to the first coil and the second coil to drive the upper rotor and the lower rotor respectively; the upper rotor is coupled to a wheel shaft, and the lower rotor is coupled to an input of the speed reducer, and an output of the speed reducer is coupled to the wheel shaft.

33. The hybrid motor structure of claim 31, wherein a ratio value of a reduction ratio of the speed reducer is equal to a ratio value of a pole-pair number of the first magnet set to a pole-pair number of the second magnet set.

34. The hybrid motor structure of claim 1, wherein the first coil further comprises a pole-changing structure, and the pole-changing structure comprises a plurality switch elements, and the pole-changing structure is able to change a pole number of the first coil.

35. The hybrid motor structure of claim 1, wherein the second coil further comprises a pole-changing structure, and the pole-changing structure comprises a plurality switch elements, and the pole-changing structure is able to change a pole number of the second coil.

36. A hybrid motor structure, comprising:
a rotor;
a stator, comprising a plurality of stator teeth, wherein the rotor and the stator are arranged in a serial direction of the hybrid motor structure;
a first coil, being wound on the stator teeth;
a first magnet set, comprising a plurality of first magnet blocks, wherein the first magnet blocks are disposed around the rotor and corresponding to the first coil; the first magnet set and the first coil form a first groove pole;
a second coil, being wound on the stator teeth; and
a second magnet set, comprising a plurality of second magnet blocks, wherein the second magnet blocks are disposed around the rotor and corresponding to the second coil; the second magnet set and the second coil form a second groove pole.

37. The hybrid motor structure of claim 37, wherein the rotor further comprises a rotor back iron, and the first magnet set and the second magnet set are disposed on the rotor back iron.

38. The hybrid motor structure of claim 36, wherein the first magnetic set is disposed on an external side of the rotor back iron and in a radial direction of the hybrid motor structure; the second magnetic set is disposed on an internal side of the rotor back iron and in the radial direction of the hybrid motor structure.

39. The hybrid motor structure of claim 36, wherein the first magnetic set is disposed on an internal side of the rotor back iron and in a radial direction of the hybrid motor structure; the second magnetic set is disposed on an external side of the rotor back iron and in the radial direction of the hybrid motor structure.

40. The hybrid motor structure of claim 36, wherein the stator teeth are disposed on the lower surface of the stator and toward the rotor.

41. The hybrid motor structure of claim 36, wherein a pole-pair number of the first coil is 1; a pole-pair number of the second coil is an integer multiple of the pole-pair number of the first coil, and the integer multiple is greater than 1.

42. The hybrid motor structure of claim 36, wherein a pole-pair number of the first coil is greater than 1; a pole-pair number of the second coil is an integer multiple of the pole-pair number of the first coil, and the integer multiple is greater than 1.

43. The hybrid motor structure of claim 36, wherein a pole-pair number of the second coil is equal to a pole-pair number of the second magnet set.

44. The hybrid motor structure of claim 41, wherein a sum of the pole-pair number of the first coil and a pole-pair number of the first magnet set is equal to a number of the stator teeth.

45. The hybrid motor structure of claim 42, wherein a sum of the pole-pair number of the first coil and a pole-pair number of the first magnet set is equal to a number of the stator teeth.

46. The hybrid motor structure of claim 43, wherein a sum of the pole-pair number of the first coil and a pole-pair number of the first magnet set is equal to a number of the stator teeth.

47. The hybrid motor structure of claim 36, wherein the second coil comprises a plurality of sub-coils, and the sub-coils are wound on the stator teeth and connected in series.

48. The hybrid motor structure of claim 36, wherein the second coil comprises a plurality of sub-coils, and the sub-coils are wound on the stator teeth; any one of the sub-coils is connected to the sub-coil at an opposite side in series to form a sub-coil set; the second coil comprises a plurality of the sub-coil sets.

49. The hybrid motor structure of claim 48, wherein the sub-coil sets are connected in series.

50. The hybrid motor structure of claim 48, wherein the sub-coil sets are connected in parallel.

51. The hybrid motor structure of claim 41, wherein the second coil comprises a plurality of sub-coil sets, and each of the sub-coil sets comprises a plurality of sub-coils; the sub-coils are wound on the stator teeth, and the sub-coils of each of the sub-coil sets are connected in series or in parallel; the sub-coil sets are connected to each other/one another.

52. The hybrid motor structure of claim 51, wherein a quantity of the sub-coils of each of the sub-coil sets is equal to a factor of the pole-pair number of the second coil, and the factor is greater than 1.

53. The hybrid motor structure of claim 52, wherein the sub-coils of each sub coil set of each sub-coil set are spaced at regular interval or substantially space at regular interval and disposed around 0-360° of a mechanical angle of a periphery of the stator, or 0-360° of an electrical angle of a magnetic field of the first coil.

54. The hybrid motor structure of claim 42, wherein the second coil comprises a plurality of sub-coil sets, and each of the sub-coil sets comprises a plurality of sub-coils wound around the stator teeth; the sub-coils of each of the sub-coil sets are connected in series or in parallel; the sub-coil sets are connected to each other/one another.

55. The hybrid motor structure of claim 54, wherein a quantity of the sub-coils of each of the sub-coil sets is equal to a factor of the pole-pair number of the second coil, and the factor is greater than 1.

56. The hybrid motor structure of claim 55, wherein the sub-coils of each sub-coil set are spaced at regular interval or substantially spaced at regular interval and disposed around 0-360° of an electrical angle of a magnetic field of the first coil.

57. The hybrid motor structure of claim 51, wherein the sub-coil sets are connected in series.

58. The hybrid motor structure of claim 51, wherein the sub-coil sets are connected in parallel.

59. The hybrid motor structure of claim 54, wherein the sub-coil sets are connected in series.

60. The hybrid motor structure of claim 54, wherein the sub-coil sets are connected in parallel.

61. The hybrid motor structure of claim 57, wherein the pole-pair number of the second coil is an integer multiple of a quantity of the sub-coils of each of the sub-coil sets.

62. The hybrid motor structure of claim 58, wherein the pole-pair number of the second coil is an integer multiple of a quantity of the sub-coils of each of the sub-coil sets.

63. The hybrid motor structure of claim 59, wherein the pole-pair number of the second coil is an integer multiple of a quantity of the sub-coils of each of the sub-coil sets.

64. The hybrid motor structure of claim 60, wherein the pole-pair number of the second coil is an integer multiple of a quantity of the sub-coils of each of the sub-coil sets.

65. The hybrid motor structure of claim 36, wherein from a radial direction of the hybrid motor structure to perceive, both of an installation range of the first coil and an installation range of the second coil cover a coil installation area of the stator.

66. The hybrid motor structure of claim 36, wherein from a radial direction of the hybrid motor structure to perceive, an installation range of the first coil covers a coil installation area of the stator, but an installation range of the second coil fails to cover the coil installation area of the stator.

67. The hybrid motor structure of claim 36, wherein from a radial direction of the hybrid motor structure to perceive, an installation range of the second coil covers a coil installation area of the stator, but an installation range of the first coil fails to cover the coil installation area of the stator.

68. The hybrid motor structure of claim 36, wherein the stator is assembled by a lamination of a plurality of silicon steel sheets, or made of a soft magnetic composite, or comprises both of the lamination of the silicon steel steels and the soft magnetic composite.

69. The hybrid motor structure of claim 36, wherein the rotor comprises an outer rotor and an inner rotor; the first magnet blocks are disposed around the outer rotor and corresponding to the first coil and the second magnet blocks are disposed around the inner rotor and corresponding to the second coil.

70. The hybrid motor structure of claim 69, further comprising a speed reducer and an inverter, wherein the inverter is coupled to the first coil and the second coil to drive the outer rotor and the inner rotor respectively; the outer rotor is coupled to a wheel shaft, and the inner rotor is coupled to an input of the speed reducer, and an output of the speed reducer is coupled to the wheel shaft.

71. The hybrid motor structure of claim 69, wherein a ratio value of a reduction ratio of the speed reducer is equal to a ratio value of a pole-pair number of the first magnet set to a pole-pair number of the second magnet set.

72. The hybrid motor structure of claim 36, wherein the first coil further comprises a pole-changing structure, and the pole-changing structure comprises a plurality switch elements, and the pole-changing structure is able to change a pole number of the first coil.

73. The hybrid motor structure of claim 36, wherein the second coil further comprises a pole-changing structure, and the pole-changing structure comprises a plurality switch elements, and the pole-changing structure is able to change a pole number of the second coil.
